(19) United States
(12) Patent Application Publication
(10) Pub. No.: US 2004/0203999 A1
(43) Pub. Date: Oct. 14, 2004

(54) Mobile phone key

(76) Inventors: Ming-Ching Liang, Anding Shiang (TW); Huei-Hsin Sun, Taipei City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/140,412

(22) Filed: May 6, 2002

(51) Int. Cl. H04M 1/00

(52) U.S. Cl. 455/550.1; 455/575.1

(57) ABSTRACT

A mobile phone key is made of metal and positioned on a faceplate, having a figure mark for a function or a number for dialing formed on a top surface of the key. The figure mark or the number is formed to protrude on or recess in the top surface of the key as a 3D configuration. The key has a support pin protruding down through the faceplate to face to an upper surface of an IC board with a proper gap so that the key may tough the IC board when it is pressed down manually, and may recover its place by a spring fitted around the support pin protruding down through a socket combined with the support pin by means of a locking ring. The key endures a long period of use, and also able to be discerned by the weak sighted and the blind by touching in using the mobile phone. So the mobile phone with the keys can have a wide scope of users.

### BACKGROUND OF THE INVENTION

This invention relates to a mobile phone key, particularly to one made of metal in a 3D mode with a figure mark or a dial number either protruding up or recessing down in a top surface of the key, and each key located in a corresponding location of an IC board below a faceplate. Then the key can retain the figure mark or the dial number intact, not wearing off in spite of long period of use. Moreover, the 3D configuration of the key is quite convenient for the weak sighted or the blind to discern by touching in use, broadening the scope of users.

At present, most mobile phones on the market have function and number keys on a faceplate made of plastic or rubber with dial numbers or figure marks printed on top. Those printed figure marks or dial numbers may wear off gradually to blur or disappear after a long period of use. In addition, those keys made of plastic or rubber may be gnawed away by cockroaches during nighttime, with its pretty appearance impaired or becoming bad looking.

### SUJMMARY OF THE INVENTION

The purpose of the invention is to offer a mobile phone key for a function/dial number made of metal, and figure marks or dial numbers are formed in 3D configurations protruding up or recessing down and located on a faceplate and above an IC board below a faceplate. Then the shapes of the function marks and the numbers can be kept intact even after a long period of use, and moreover, they are very convenient for the weak sighted and the blind to discern by touching, broadening the scope of users.

The feature of the invention is every mobile phone key having a support pin extending down from its bottom, a spring, a limit washer and more than one waterproof rings orderly fitted around the support pin. Then each key is resiliently deposited in a venter hollow space in a socket, with the support pin extending down through a center hole formed in a bottom wall of the socket. The support pin has an annular groove in a lower portion protruding out of the socket for a C-shaped locking ring to engage and keep each key located on the faceplate and its lower end of the support pin facing the IC board with a proper gap so that the key can be pressed down manually to touch the IC board and recover its position by means of a spring fitted around the support pin after released.

### BRIEF DESCRIPTION OF DRAWINGS

This invention will be better understood by referring to the accompanying drawings, wherein:

FIG. 1 is an exploded perspective view of a mobile phone key in the present invention;

FIG. 2 is a half cross-sectional view of the mobile phone key in the present invention; and,

FIG. 3 is a cross-sectional view of the mobile phone keys located between a faceplate and an IC board in the present invention.

### DETAILED DESCRIPTION OF THE PREFERRED EMBODIMENT

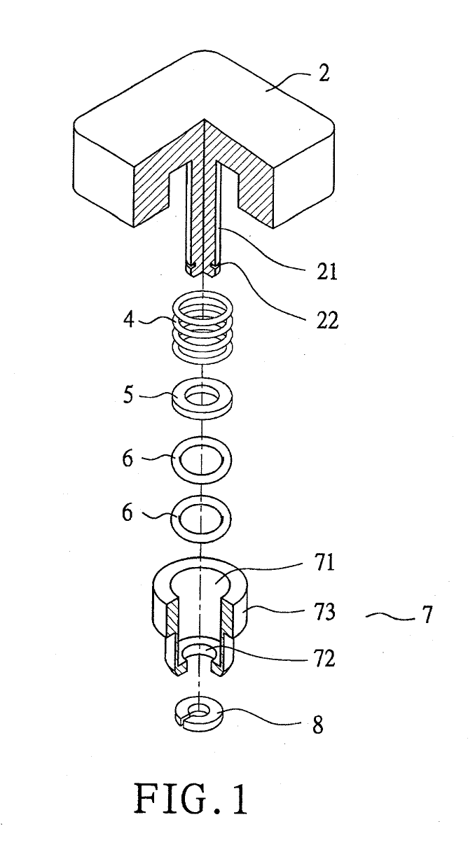

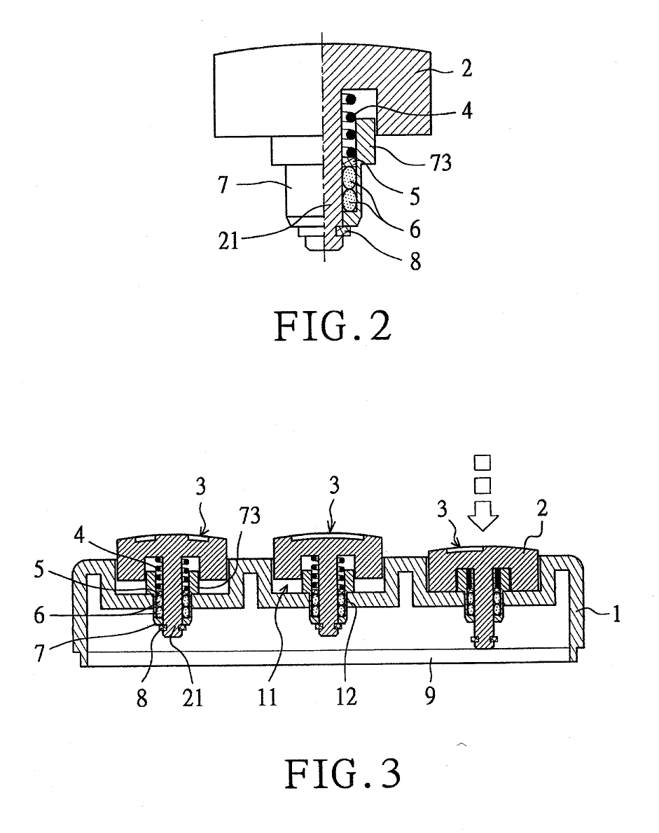

A preferred embodiment of a mobile phone key in the present invention, as shown in FIG. 1, includes a function/dial number key 2 combined on a faceplate of a mobile phone and made of metal, and a figure mark or a number 3 formed to protrude or recess in a top surface of the key 2. Each key 2 has a support pin 21 extending down from its bottom, a spring 4, a limit washer 5 and more than one waterproof rings 6 fitted around the support pin 21. Then the support pin 21 together with the spring 4, the limit washer 5 and the waterproof rings 6 is deposited in a center hollow space 71 of a socket 7, with the support pin 21 having its lower end protruding down through a center hole 72 formed in a lower wall of the socket 7. The support pin 21 has an annular groove 22 formed in a lower portion protruding out of the socket 7 for a C-shaped locking ring 8 to engage and secure the socket 7 with the support pin 21 in place

Then each key 2 is placed in a recess 11 formed spaced apart regularly in a faceplate 1, with each socket 7 provided with an annular upper large-diameter wall 73 receiving the support pin 21 with the spring 4, the limit washer 5 and the waterproof rings 6 in the hollow space 71 defined by the annular upper wall 73. Further, the lower portion of each support pin 21 and a lower small diameter portion of the socket 7 protrude down through a hole 12 of the faceplate 1 in a secured condition, as shown in FIG. 3, with the end of the lower portion of the support pin 21 facing a corresponding location of an upper surface of the IC board with a proper gap. Thus the key 2 can be pressed down manually to let the lower end of the support pin 21 touch the IC board 9 to perform its function.

In using, as shown in FIG. 3, any of the keys 2 is pressed down to the IC board 9 and touches a corresponding location of the upper surface of the IC board 9 to perform its function. Then the finger pressing the key is released to let the key 2 recover its position by means of the spring 4. As the keys 2 are all made of metal, possible to endure long time of use to keep the figure marks or the dial numbers intact, not wearing off even if used for a long period of time. Moreover, the weak sighted or the blind can discern the figure mark or the number by touching on the key 2 owing to its protruding or recessed configuration of 3D.

While the preferred embodiment of the invention has been described above, it will be recognized and understood that various modifications may be made therein, and the appended claims are intended to cover all the modifications, which may fall within the spirit and scope of the invention.

What is claimed is:

1. A mobile phone key made of metal, combined on a faceplate of a mobile phone and comprising a figure mark for indicating a function, a number for dialing provided on a top surface of each said key and formed to protrude or recess in the top surface as 3D, each said key located to face downward to a corresponding location of an upper surface of an IC board; and,
Said mobile phone key retaining said figure mark or said number intact even if used for a long period of time and able for the weak sighted or the blind to easily discern by touching in using said mobile phone.

2. A mobile phone key comprising a support pin extending down from a center of an upper block portion fitted in one of plural recesses formed regularly in an upper surface of a faceplate, a spring, a limit washer and more than one waterproof rings orderly fitted around said support pin, said support pin together with said spring, said limit washer and said waterproof rings deposited in a center hollow space of a socket, said support pin protruding downward through a center hole in a bottom wall of said socket, a lower portion of said support pin protruding out of said socket and having an annular groove for a C-shaped locking ring to engage therein so as to secure said socket with said support pin; each said key located on said faceplate with said support pin having its lower end facing down to an upper surface of an IC board and separated with a proper gap so that each said key can tough on a corresponding location of the upper surface of an IC board when it is pressed down manually, said mobile phone made to have waterproof function.
